(19) United States
(12) Patent Application Publication
(10) Pub. No.: US 2011/0155619 A1
(43) Pub. Date: Jun. 30, 2011

(54) Method and Apparatus for Facilitating the Simultaneous Firing of Multi-Piece Stoneware Object Having Both Glazed and Unglazed Surfaces

(76) Inventor: Robert S. Harris, Northbrook, IL (US)

(21) Appl. No.: 12/720,468

(22) Filed: Mar. 9, 2010

Related U.S. Application Data
(60) Provisional application No. 61/161,657, filed on Mar. 19, 2009.

(51) Int. Cl. B65D 90/54; B05D 1/32; B05D 5/00; B05D 3/02; C04B 33/34

(52) U.S. Cl. 206/524.1; 427/282; 427/256; 264/600

(57) ABSTRACT

The present disclosure provides a method of manufacturing ceramic objects having glazed and unglazed surfaces and a multi-piece, selectively assembled ceramic object. The present disclosure overcomes the necessity of separately firing multi-piece ceramic objects, such as stoneware products, having both glazed and unglazed surfaces. In accordance with the present disclosure, a bowl having a fully glazed rim and a lid having at least a partially glazed rim can be fired with the lid in place covering the bowl. In this manner, more complete pieces can be fired over time resulting in greater throughput and energy savings. In addition, by firing the two pieces together, it is expected that there will be greater dimensional stability or less distortion than by firing the two pieces separately.

### PRIORITY

The application claims priority to U.S. Provisional Patent Application No. 61/161,657, filed Mar. 19, 2009.

### FIELD

The present disclosure relates to a method and apparatus for facilitating the simultaneous firing of multi-piece ceramic object having both glazed and unglazed surfaces.

### BACKGROUND

The present disclosure is presented in the context of a round covered stoneware baking dish, with the understanding that the concepts of the present disclosure are applicable to other ceramic cookware items, including square, rectangular, and oval covered baking dishes, as well as other fired products that include both glazed and unglazed surfaces.

Ceramic cookware of the type disclosed herein is most commonly described as either glazed or unglazed. An unglazed stoneware baking dish is manufactured by forming a clay-based body into a desired shape, typically through automated means such as ram pressing, drying and then firing the object in a kiln at temperatures approaching 2,000 degrees during which the clay-based body is converted into what is classified as a ceramic. A finished unglazed piece typically is beige or golden in color, though the exact color is dependant upon the composition of the body including the clay and/or other chemicals or minerals added prior to forming and firing. An unglazed stoneware cookware baking dish is valued for its heat retention properties as well as the porosity of the stoneware itself.

A finished glazed piece on the other hand typically has a smooth non-porous high gloss or semi-gloss colored glassy surface. Glazed stoneware cookware has become very desirable for the inherent aesthetic appearance of the glaze finish itself and for its ability to be colored providing an enhanced visual appearance permitting use both as cookware and as a presentation piece, such as at the dinner table. The glazed surface is generally non-porous and typically easier to clean and maintain than an unglazed surface.

It is further desirable to provide stoneware cookware that has both glazed outer surfaces and unglazed inner surfaces. While such cookware is indeed popular, manufacturing such cookware is complex and presents inherent inefficiencies in the manufacturability of same.

To illustrate such complexities and inefficiencies, FIG. 8 is a cross-sectional view of a prior art covered stoneware baking dish having an inner unglazed surface and outer glazed surface, specifically showing the lid 11 in place on bowl 10. As shown, the outer facing surfaces of bowl 10 and lid 11 are glazed, as indicated by reference number 12, while the inner facing surfaces are unglazed, as indicated by reference numeral 13. The under-facing surface A of the rim 15 of the lid 11 is glazed. Likewise, the upper-facing surface B of the rim 14 of bowl 10 is also glazed. Thus, glazed surfaces A and B abut one another when the dish is covered, such as when placed in an oven and used for cooking.

The desire to glaze either of lower surface A of lid 11 or upper surface B of bowl 10 precludes firing both the lid and bowl in their assembled orientation because when so doing glazed surface A will fuse to glazed surface B. Even if one were to omit glazing either surface A or B, the glazed surface will still fuse to the opposing unglazed surface if in contact with each other when fired_{—}

Accordingly, in order to manufacture an object having the above-described opposing glazed surfaces, the bowls must be fired separately from the lids. Firing these two pieces separately takes up more space on each kiln used to carry items as they pass through the kiln. As a result, fewer complete cookware products can be manufactured in a given period of time.

### SUMMARY

The present disclosure overcomes the necessity of separately firing multi-piece stoneware objects having both glazed and unglazed surfaces. In accordance with the present disclosure, a bowl having a fully glazed rim and a lid having at least a partially glazed rim can be fired with the lid in place covering the bowl. In this manner, more complete pieces can be fired over time resulting in greater throughput and energy savings. In addition, by firing the two pieces together, it is expected that there will be greater dimensional stability or less distortion than by firing the two pieces separately.

In one embodiment, the present disclosure provides a method of manufacturing ceramic objects having glazed and unglazed surfaces. The method includes providing first and second ceramic components, each of the first and second ceramic components having a glazed outward-facing surface and an unglazed contact region. The method further includes mechanically interfacing the first and second ceramic components at the unglazed contact regions, with the glazed outward-facing surface of the first ceramic component being spaced apart from the second ceramic component, and with the glazed outward-facing surface of the second ceramic component being spaced apart form the first ceramic component. The method further includes contemporaneously firing the mechanically interfaced first and second ceramic components.

The present disclosure also provides a method of manufacturing selectively engageable ceramic objects having glazed and unglazed surfaces. The method includes providing an unglazed first ceramic component defining a first contact region and an unglazed second ceramic component defining a second contact region. The method further includes applying a first glaze to a surface of the first ceramic component outside of the first contact region and applying a second glaze to a surface of the second ceramic component outside of the second contact region. The method further includes engaging the first contact region of the first ceramic component and the second contact region of the second ceramic component and contemporaneously firing the engaged first and second ceramic components.

In another embodiment, the present disclosure provides a multi-piece, selectively assembled ceramic object having glazed and unglazed surfaces. The ceramic object includes a container defining a bottom portion and a substantially upright body portion extending away from the bottom portion, the body portion having a glazed outer-facing surface and an unglazed top surface opposite the bottom portion. The ceramic object further includes a removable cover complementary to the container, the cover having a core portion and a rim portion extending about the core portion, the core portion having a glazed outer-facing surface, and the rim portion having an unglazed surface. In this embodiment, a removable engagement of the container and the cover form the assembled ceramic object, with the unglazed top surface of the body portion of the container and the unglazed surface of the rim of the cover contacting each other and defining the removable engagement of the container and the cover.

Further objects and advantages of the present disclosure, together with the organization and manner of operation thereof, will become apparent from the following detailed description when taken in conjunction with the accompanying drawings.

### BRIEF DESCRIPTION OF THE DRAWINGS

FIG. 1 is a perspective view of an assembled stoneware baking dish constructed and manufactured according to the principles of the present disclosure;

FIG. 2 is an exploded perspective view of the dish of FIG. 1;

FIG. 3 is a side view of the lid of the dish of FIG. 1;

FIG. 4 is a side view of the bowl of the dish of FIG. 1;

FIG. 5 is a side view of the dish of FIG. 1 with the lid and bowl disengaged according to the principles of the present disclosure;

FIG. 6 is a side view of the dish of FIG. 1 with the lid and bowl engaged according to the principles of the present disclosure;

FIG. 7 is a partial cross-sectional view of the dish of FIG. 1 with the lid and bowl engaged according to the principles of the present disclosure;

FIG. 8 is a partial cross-sectional view of a prior art stoneware dish;

FIG. 9 is a bottom view of the lid of the dish of FIG. 1;

FIG. 10 is a schematic view of a mask for the lid of the dish of FIG. 1 according to the principles of the present disclosure;

FIG. 11 is a top view of the bowl of the dish of FIG. 1;

FIG. 12 is a schematic view of a mask for the bowl of the dish of FIG. 1 according to the principles of the present disclosure;

FIG. 13 is a partial schematic view of an alternative mask for the bowl of the dish of FIG. 1 according to the principles of the present disclosure; and

FIG. 14 is a schematic chart of a method of manufacturing a multi-piece, selectively assembled ceramic object according to the principles of the present disclosure.

### DETAILED DESCRIPTION OF THE DISCLOSURE

The present disclosure is further described with reference to the accompanying drawings, which show particular embodiments of the disclosure. However, it should be noted that the accompanying drawings are merely exemplary. For example, the various elements and combinations of elements described below and illustrated in the drawings can vary to result in embodiments which are still within the spirit and scope of the present disclosure.

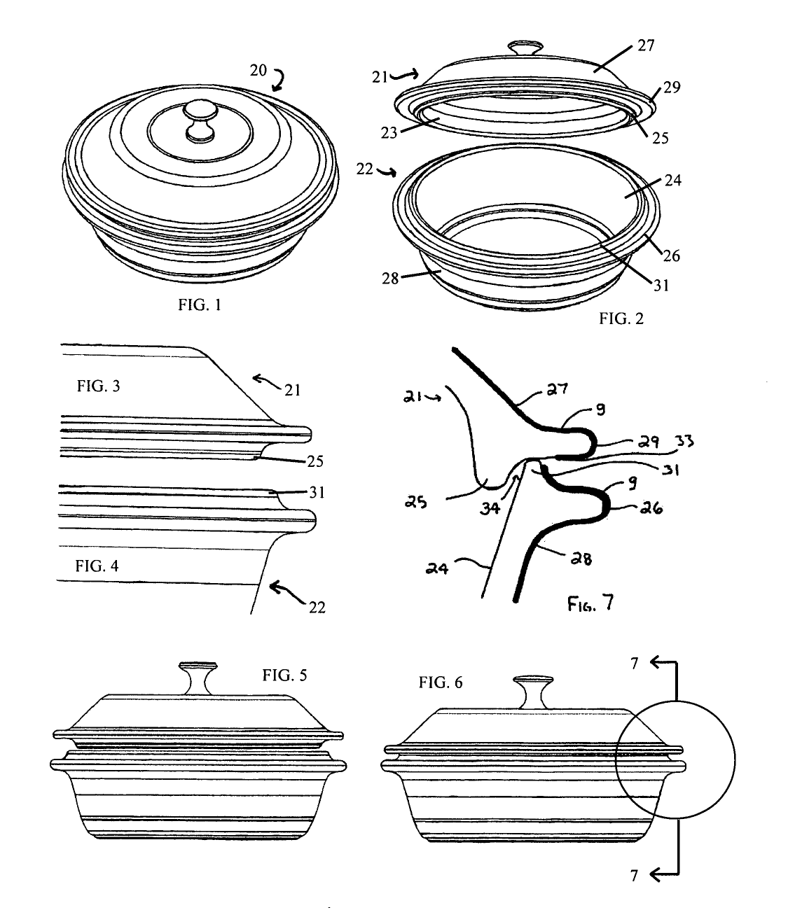

FIGS. 1-7 of the drawings illustrate a multi-piece, selectively engageable ceramic object 20, in the form of a stoneware baking dish, configured and manufactured according to the present principles of the present. As illustrated in FIG. 2, dish 20 includes a cover component in the form of lid 21 and a container component in the form of bowl or basin 22. With further reference to FIG. 7, Lid 21 has an inner-facing, unglazed surface 23 and a outer facing glazed surface 27. Lid 21 further includes portions in the form of a foot 25 and a rim 29. Bowl 22 has an inner-facing unglazed surface 24 and an outer-facing glazed surface 28. Bowl 22 defines portions in the form of a rim 26 and a projection 31.

With continued reference to FIG. 7, the construction and interposition of lid 21 and bowl 22 are illustrated. Specifically, in FIG. 7, lid 21 is positioned to mechanically interface or engage with bowl 22 and, thus, serve as a cover for the interior cavity of bowl 22. Foot 25 of lid 21 is telescopically received within the interior cavity of bowl 22 and is spaced away from inner-facing surface 24, leaving a gap 34. In this illustrated embodiment, glazed surface g extends along the outer facing surface 27 onto rim 29 and along the underside or lower-facing surface of rim 29, as denoted by reference numeral 33 Accordingly, the contact region of lid 21, the area configured to directly engage bowl 22, remains unglazed.

The construction of bowl 22 differs from that found in the prior art, such as illustrated in FIG. 8. Specifically, referring to FIG. 7, bowl 22 is includes projection 31 which emanates upward from rim 26 such that rim 26 does not contact rim 29 when the lid is in position covering the bowl. As illustrated and denoted by glazed surface g, outer-facing surface 28 of bowl 22 is glazed and includes the entirety of rim 26. However, the glaze surface g does not cover projection 31, leaving the top surface of projection 31 unglazed. Accordingly, the contact region of bowl 22, the area configured to directly engage lid 21, remains unglazed.

Therefore, when bowl 22 is covered with lid 21, the unglazed surface of lid 21 is in contact with an unglazed surface of bowl 22. Dish 20 can thus be fired with lid 21 in position covering bowl 22 without the two pieces becoming fused together during the firing process.

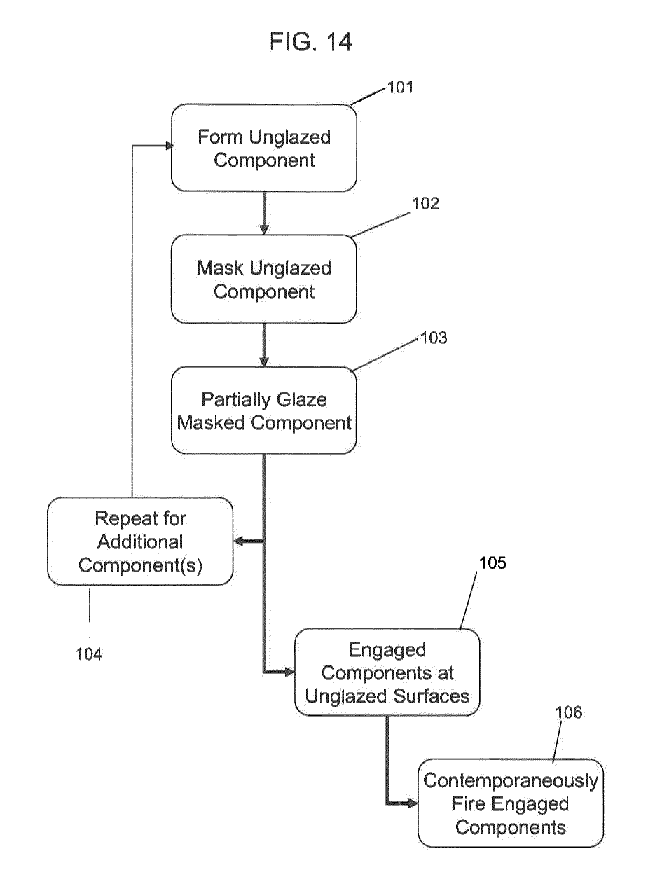

With reference to the schematic illustration of FIG. 14, a ceramic object according to the principles of the present disclosure, such as a stoneware baking dish, may be constructed and manufactured as follows. As represented at 102 on FIG. 14, it is contemplated that the components, such as a lid and basin, may be fabricated using various body compositions and formed into their desired shapes according to any one of a number of known techniques, such as formed by a ram press and dried in a conventional manner.

Referring to 102-102 of FIG. 14, glaze is then applied in a manner such that the glaze does not cover the surfaces of the components, such as a lid and bowl, where the components contact one another during firing. For example, as disclosed in the above-discussed embodiment, when lid 21 is in position covering bowl 22, the unglazed contact regions of lid 21 and bowl 22 are defined as a portion of projection 31 of bowl 22 and a portion of the under-facing surface of rim 29 of lid 21 where the two components directly engage one another.

To provide these unglazed contact regions, according to the principles of the present disclosure, a mask is used during the application of glaze to each component to ensure accurate and controlled application of the glaze. The glazing of the pieces may be performed manually or by an automated robot-driven system. FIG. 10 illustrates an exemplary mask 40 that is temporarily affixed to the under-facing surface of lid 21 during glazing. Mask 40 is shown in schematic form and without gaskets typically used. Mask 40 is configured to shield the immediately underlying surface of the lid and thus prevents glaze from coming in contact with the shielded surface as glaze is sprayed or otherwise applied to the lid. In a preferred embodiment, mask 40 is round, so as to be complementary shaped to lid 21, and includes a circular groove 41 formed therein. Groove 41 conforms substantially to the shape of foot 25 whereby mask 40 is appropriately and automatically centered on the under-facing surface of lid 21 so that, in turn, a mask edge 42 leaves a substantially symmetrical exposed area 33 along the periphery of the under-facing surface of rim 29, to which glaze can be evenly applied.

Referring to 104 of FIG. 14, this process may be repeated for another component, such as for bowl 22 of the dish 20 discussed in detail above. FIG. 12 illustrates an example of mask 20 that is temporarily affixed to the upper-facing surface of bowl 22 during glazing. Mask 50 is shown in schematic form and without gaskets typically used. A mask 50, as shown, is round and includes groove 51 that is shaped to substantially correspond to the shape of projection 31 to thereby center the mask on bowl 22 and permit an even application of glaze around the outer surface of bowl 22, rim 26 and only a portion of projection 31. Mask 50 may be formed to fully conform to the cavity of bowl 22 as indicted by dashed lines. Alternatively, as illustrated in FIG. 13, mask 50 may include a groove 52 and edge 53 which fully insulates projection 31 from receiving glaze and results in only a portion of the upper-facing surface of rim 26 being glazed.

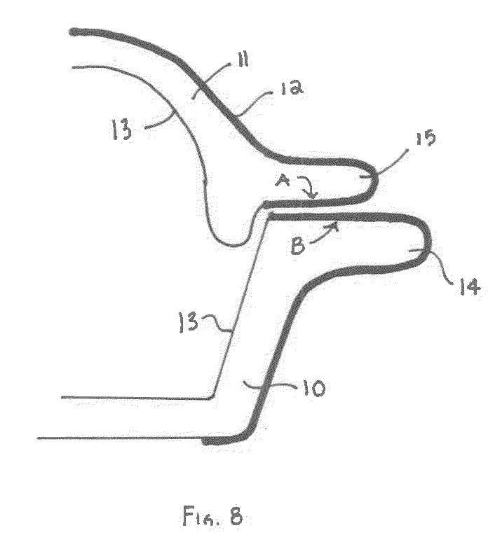

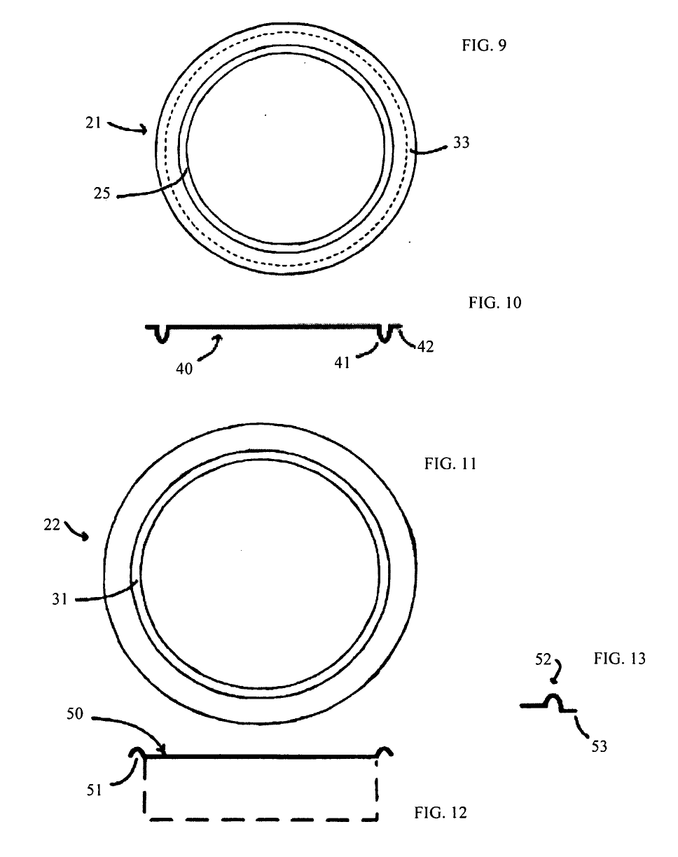

The multiple, partially glazed components according to the principles of the present disclosure may be engaged between their unglazed surfaces, as indicated at 102 of FIG. 14. Referring again to dish 20 as an example, and as illustrated in FIGS. 3 and 4, lid 21 and basin 22 included glazed and unglazed surfaces thereon. As shown in FIGS. 5 and 6, lid 21 is telescopically received into basin 21 and, when fully engaged, only unglazed surfaces are in contact with one another.

Referring to 106 of FIG. 14, a ceramic object with both glazed and unglazed surfaces according to the principles of the present disclosure, such as a stoneware cookware product, is fired in with the components assembled together and directly interfacing or engaging with each other. An object manufactured according to these principles may present an aesthetically glazed outer surface and an unglazed inner surface, on two or more components, fired contemporaneously.

While a two piece round baking dish sometimes referred to as a casserole or roaster, as disclosed in the drawings, the present disclosure is equally applicable to cookware of other shapes such as oval, square, or rectangular covered pieces. Moreover, the invention disclosed herein in likewise applicable to cookware composed of more than two pieces such as a divided basin or bowl having multiple covers. It is additionally contemplated that the invention disclosed herein can be used to permit the firing of other multi-piece products in a manner in which the two or more pieces are juxtaposed to one another during firing.

It should be appreciated that the present disclosure can vary in many ways. For example, it should be understood that the method of manufacture of a multi-piece ceramic object according to the principles of the present disclosure can be used in a variety of applications. Moreover, a ceramic object according to the present disclosure can have a varying number of components. Additionally, the materials and shapes of the ceramic objects according to the principles of the present disclosure can vary, as is well known in the relevant arts. Accordingly, it is to be understood that the present disclosure is exemplary in nature.

What is claimed is:

1. A method of manufacturing ceramic objects having glazed and unglazed surfaces, the method comprising:
providing first and second ceramic components, each of said first and second ceramic components having a glazed outward-facing surface and an unglazed region;
positioning said first ceramic component in contact with said second ceramic component wherein said unglazed regions contact one another and wherein said glazed outward-facing surface of said first ceramic component being spaced apart from said second ceramic component and said glazed outward-facing surface of said second ceramic component is spaced apart from sad first ceramic component;
simultaneously firing said first and second ceramic components while in contact with each other.

2. The method of claim 1, wherein said first and second ceramic components are complementary pieces of a multi-piece partially glazed ceramic product.

3. The method of claim 2, wherein said first ceramic component is a bowl-shaped container and said second ceramic component is a cover for said bowl-shaped container.

4. The method of claim 3, further comprising removing said cover from said bowl-shaped container after firing.

5. The method of claim 1, wherein the invention further includes the steps of:
masking a portion of each of said first and second ceramic components; and
glazing an unmasked, outward-facing surface of each of said first and second ceramic components.

6. A method of manufacturing selectively engageable ceramic objects having glazed and unglazed surfaces, the method comprising:
providing an unglazed first ceramic component having a first contact region and an unglazed second ceramic component having a second contact region;
applying a glaze to said first ceramic component outside of said first contact region;
applying said glaze to said second ceramic component outside of said second contact region;
positioning said first contact region of said first ceramic component so as to abut said second contact region of said second ceramic component; and
simultaneously firing said first and second ceramic components.

7. The method of claim 6, wherein said first and second ceramic components are complementary pieces of a multi-piece ceramic product.

8. The method of claim 7, wherein said first ceramic component is a bowl-shaped container and said second ceramic component is a cover for said bowl-shaped container.

9. The method of claim 8, wherein applying said glaze to said first ceramic component includes:
positioning a mask over at least said first contact region of said first ceramic component ; and
applying said glaze to said first ceramic component wherein said mask precludes application of said glaze to said first contact region.

10. The method of claim 9, wherein applying said glaze to said first ceramic component includes:
positioning a mask over at least the second contact region of said second ceramic component; and
applying said glaze to said second ceramic component wherein said mask precludes application of said glaze to said second contact region.

11. A multi-piece, ceramic object having partially glazed and partially unglazed surfaces, the ceramic object comprising:
a container defining a bottom surface and a substantially upright body portion extending upward from said bottom surface, said body portion having a glazed outer-facing surface and an unglazed top facing edge surface; and
a removable cover complementary to said container, said cover having a core portion and a rim portion extending about the periphery of said core portion, said core portion having a glazed outer-facing surface, said rim portion having a partially unglazed bottom facing surface,
wherein juxtaposition of said container and said cover forms the assembled ceramic object, with said unglazed top facing edge of said body portion of said container and said unglazed bottom facing surface of said rim of said cover contacting each other and defining said removable engagement of said container and said cover.

12. The ceramic object of claim 11, wherein said bottom facing surface of said cover further includes a substantially downwardly extending foot proximate said rim portion, said foot generally conforming to an inner-facing surface of said body portion of said container proximate said top edge, said foot extending across a plane defined by said unglazed surface of said rim portion of said cover,

13. The ceramic object of claim 12, wherein said rim portion of said cover includes an outer-facing glazed surface.

14. The ceramic object of claim 11, wherein said container further includes a glazed outwardly-extending rim disposed about a periphery of said body portion.

14. The ceramic object of claim 11, wherein said rim portion of said cover includes an outer-facing glazed surface.

15. The ceramic object of claim 11, wherein said container and said cover have complementarily rounded shapes.

16. The ceramic object of claim 11, wherein said container and said cover are stoneware objects for use in a cooking environment.
